(19) United States
(12) Patent Application Publication
(10) Pub. No.: US 2023/0273115 A1
(43) Pub. Date: Aug. 31, 2023

(54) Sensor

(71) Applicant: Endress+Hauser Conducta GmbH+Co. KG, Gerlingen (DE)

(72) Inventors: Ralf Bernhard, Stuttgart (DE); Joachim Bolle; Thilo Krätschmer, Gerlingen (DE)

(21) Appl. No.: 18/176,066

(22) Filed: Feb. 28, 2023

(30) Foreign Application Priority Data
Feb. 28, 2022 (DE) 10 2022 104 685.0

(51) Int. Cl. G01N 21/17; G01N 15/06

(52) U.S. Cl. CPC G01N 21/17; G01N 15/06; G01N 2015/0693; G01N 2021/1738; G01N 2201/0638

(57) ABSTRACT

A sensor includes: a transmitting device which transmits radiation along a path to a medium, and a measuring device which receives measuring radiation resulting from an interaction of the transmitted radiation with the medium and determines a measurand of the medium, with which at least one property of the transmitted radiation interacting with the medium can be determined and/or monitored in a cost-effective, space-saving manner; a prism in the path, through which prism a first portion of the transmitted radiation propagates in the direction of the medium and at which a second portion of the transmitted radiation is reflected; and a reference detector which receives the second component reflected at the prism and provides an output signal representing at least one property of the second component of the transmitted radiation.

The present application is related to and claims the priority benefit of German Patent Application No. 10 2022 104 685.0, filed on Feb. 28, 2022, the entire contents of which are incorporated herein by reference.

### TECHNICAL FIELD

The present disclosure relates to a sensor for measuring a measurand of a medium, with a transmission device which is designed to transmit electromagnetic transmitted radiation along a transmission path to the medium, and a measuring device which is designed to receive measuring radiation resulting from an interaction of the transmitted radiation with the medium, to determine the measurand based on the received measuring radiation and to provide a measurement result of the measurand.

### BACKGROUND

Sensors comprising a transmission device and a measuring device receiving measuring radiation resulting from an interaction of transmitted radiation with the medium, such as optical sensors and spectrometers, are currently already used in many different applications. With these sensors, different measurands can be measured depending on the type of interaction. Examples known from the prior art include turbidity sensors for measuring turbidity of the medium, sensors for measuring a solid concentration contained in the medium, fluorescence sensors, sensors operating according to the principle of fluorescence quenching, sensors operating according to the principle of attenuated total reflection, and absorption sensors such as sensors for measuring a spectral absorption coefficient, along with sensors for measuring a concentration of an analyte containing the medium.

For the measurement of turbidity, as well as for the measurement of the concentration of solids contained in the medium, light is usually transmitted into the medium, and an intensity of the measuring radiation scattered or reflected by the particles contained in the medium, which depends on the respective measurand, is measured.

With fluorescence sensors, the procedure is such that, for example, a fluorescent component contained in the medium is excited by light irradiated into the medium, and the intensity of the fluorescence radiation resulting from the excitation is measured.

An embodiment of a fluorescence sensor is described in DE 10 2017 115 661 A1. This sensor comprises a transmission device by means of which transmitted radiation is radiated into the medium via a prism inserted into the transmission path at the end, and a measuring device by means of which measuring radiation reflected in the direction of the prism is received by the prism.

Alternatively, fluorescence measurements can also be carried out according to the principle of fluorescence quenching. This principle is used, for example, in oxygen sensors. In this case, the sensor comprises, for example, an oxygen-permeable layer which is in contact with the medium and comprises fluorescent macromolecules on which oxygen molecules contained in the medium can adhere in such a way that they weaken the fluorescent light emitted by the macromolecules. This weakening makes it possible, for example, to determine the oxygen partial pressure of the oxygen contained in the medium based on the intensity of the fluorescent light.

With absorption measurements, transmitted radiation generated by means of the transmission device is transmitted through the medium, for example, and the measurand such as a spectral absorption coefficient of the medium or a concentration of an analyte contained in the medium, is determined based on the spectral intensity or the intensity spectrum of the measuring radiation emerging from the medium.

Regardless of the type of interaction used for determining the particular measurand such as, for example, absorption, reflection, scattering or fluorescence, the problem with all of these sensors is that at least one property, in particular the intensity, of the transmitted radiation is always also substantially involved in the measurement. However, these properties can change with time and/or depending on the temperature. The transmission intensity of transmission devices such as light-emitting diodes, for example, can therefore change due to aging and/or depending on the temperature. Accordingly, there is the risk that changes of properties of the transmitted radiation that are relevant for the measurements can lead to impairments of the measurement quality, in particular the measurement accuracy.

This problem can be countered, for example, by the fact that these sensors are equipped with a reference detector for measuring and/or monitoring the property(ies) of the transmitted radiation, such as the intensity thereof. This offers the advantage that alternating transmission devices can be replaced in a timely manner, and/or an influence of the property(ies), which may change over time, of the transmitted radiation emitted by the transmission device on the measurement of the measurand can be compensated.

Thereby, the reference detector can be arranged, for example, in such a way that it directly receives a portion of the transmitted radiation generated by the transmitting device along a reference path that is different from the transmission path. This solution can be realized easily and cost-effectively without additional optical elements. A disadvantage, however, is that any changes in the properties of the radiation transmitted in the direction of the medium along the transmission path cannot be detected with this reference detector. Such changes can be caused, for example, by optical elements inserted in the transmission path, such as filters or lenses, which have an influence on the transmitted radiation, on the spatial radiation characteristic, and/or on the spectral radiation characteristic that may vary over time. These influences may also have a disadvantageous effect on the measurement quality. This case can occur, for example, if optical elements age, if optical elements are mechanically displaced, for example by vibrations relative to the transmission path, and/or if optical elements with temperature-dependent optical properties are inserted.

In order to also be able to take into account changes that may occur in the transmitting radiation interacting with the medium along the transmitting path, a beam splitter can be inserted into the transmission path through which a first portion of the transmitted radiation incident thereon passes in the direction of the medium, and at which a second portion of the transmitted radiation incident thereon is reflected in the direction of the correspondingly positioned reference detector. This offers the advantage that, at least between the transmission device and the beam splitter, possibly occurring changes in the transmitted radiation can also be detected by means of the reference detector and accordingly taken into account. However, it is disadvantageous that the beam splitter represents an additional component that requires additional space in the sensor and increases the production costs.

### SUMMARY

It is an object of the present disclosure to provide a sensor with which at least one property of the transmitted radiation interacting with the medium can be determined and/or monitored in a cost-effective, space-saving manner and, in particular, any changes in the transmitted radiation that occur in particular along the transmission path are taken into account.

For this purpose, the present disclosure comprises a sensor for measuring a measurand of a medium, including:
a transmission device which is designed to transmit electromagnetic transmitted radiation along a transmission path to the medium;
a measuring device which is designed to receive measuring radiation resulting from an interaction of the transmitted radiation with the medium, to determine the measurand based on the received measuring radiation, and to provide a measurement result of the measurand;
a prism inserted at the end into the transmission path, wherein the prism is designed and arranged such that a first portion of the transmitted radiation incident on the prism propagates through the prism in the direction of the medium, and a second portion of the transmitted radiation incident on the prism is reflected at the prism; and
a reference detector which is designed to receive the second portion of the transmitted radiation reflected at the prism and to provide, on the basis of the second portion, an output signal representing at least one property of the second portion of the transmitted radiation reflected at the prism.

The present disclosure has the advantage that the reference detector receives the second portion of the transmitted radiation reflected by the prism inserted at the end in the transmission path. This offers the advantage that the output signal of the reference detector takes into account any changes such as an intensity of the transmitted radiation that depends on the aging state and/or temperature of the emitter. Another advantage is that the output signal of the reference detector also takes into account any influences acting on the transmitted radiation along the transmission path such as, for example, optical properties of optical elements inserted in the transmission path which are dependent on the aging state and/or the temperature, along with the influence of these optical properties, which may vary over time, on the spatial and/or spectral radiation characteristic of the first portion of the transmitted radiation which is radiated into the medium.

Another advantage is that the reference detector can be arranged in the immediate vicinity of the prism, and apart from the prism that is also used for coupling the transmitted radiation into the medium, no additional components are required. This enables the reference measurements to be carried out cost-effectively, requiring very little space in the sensor, and they can be used in particular in sensors of very small size.

Embodiments of the present disclosure provide that the sensor: is designed as a turbidity sensor, is designed as a sensor for measuring a solid concentration contained in the medium, is designed as a fluorescence sensor, is designed as a sensor operating according to the principle of fluorescence quenching, is designed as an oxygen sensor operating according to the principle of fluorescence quenching, is designed as an ATR sensor operating according to the principle of attenuated total reflectance, or is designed as an absorption sensor.

According to a first further development, a coating designed as a partial reflection coating, or as an anti-reflection coating, or a spectrally selective coating is arranged on a first outer surface of the prism on which the transmitted radiation transmitted along the transmission path impinges.

According to a second development, a spectrally selective coating is arranged on a second outer surface of the prism through which measuring radiation emerges from the prism, and/or a spectrally selective coating is arranged on a third outer surface of the prism facing the medium.

According to a development of the first and/or the second development, the spectrally selective coating or at least one of the spectrally selective coatings is designed as a filter, as an interference filter, as a dichroic filter, as a color filter, as a spectral filter that is transparent at one or more spectral lines or as a bandpass filter that is transparent in a limited wavelength range.

A third development comprises a sensor wherein the prism:
is designed as a process separator by which an interior of the sensor is separated from the medium; and/or
is mounted on or in the housing of the sensor such that the prism closes a housing opening of the sensor; and/or
has a first outer surface arranged in the housing of the sensor, through which the first portion of the transmitted radiation incident thereon passes and at which the second portion of the transmitted radiation is reflected to the reference detector, and has a third outer surface in contact with the medium during measurement mode.

Another development of the third development has a sensor wherein the prism has an outwardly projecting outer edge region, wherein: the prism is fastened on or in the sensor by means of the edge region, and/or the edge region: a) is connected to the housing of the sensor by a joint or an adhesive bond, b) is clamped in the sensor by means of a clamping device, or c) is clamped between an end face of the housing and a union nut mounted on the housing.

A development of the last-mentioned development comprises a sensor wherein the prism:
has a first region arranged in the housing and comprising the first outer surface;
has a second region which comprises the outwardly projecting outer edge region; and
the second region either comprises the third outer surface or adjoins a third region of the prism which comprises the third outer surface, wherein the third region has a smaller base area than the second region and/or is designed such that the third outer surface terminates flush with an outer side of the sensor or an end face of the union nut.

One embodiment comprises a sensor wherein the measuring device is connected to the reference detector, and the measurement result is determined based on the received measuring radiation and the property, at least one of the properties, or each of the properties, of the second portion of the transmitted radiation reflected at the prism.

Another embodiment includes a sensor wherein:
the measuring device comprises a measuring detector which is designed to receive the measuring radiation and to output a detector signal dependent on the measurand;
the measuring device comprises measuring electronics connected to the measuring detector; and
the measurement electronics are designed to determine and provide the measurement result as a measurement result compensated with respect to a dependence of a property of the measurement radiation, which is dependent on the measurand, on the property, at least one of the properties, or each of the properties of the second portion of the transmitted radiation reflected at the prism.

An additional development comprises a sensor wherein a monitoring device is connected to the reference detector, which monitoring device is designed to monitor the property, or at least one or each of the properties of the second portion of the transmitted radiation reflected at the prism, and/or to output an alarm if the property, or at least one of the properties, lies outside a setpoint range specified for the particular property.

According to another development, the reference detector is arranged in a housing of the sensor in a region externally surrounding the prism, and/or is arranged in a recess in a housing wall of the housing of the sensor.

According to an embodiment, the first outer surface of the prism on which the transmitted radiation impinges, a second outer surface of the prism and a third outer surface of the prism facing the medium are arranged in a triangle.

An embodiment of the latter embodiment comprises a sensor wherein the measuring device receives the measuring radiation via a reception path, and the reception path comprises a section that extends antiparallel to the section of the transmitting path extending from the transmitting device to the first outer surface of the prism, and extends from the second outer surface of the prism to the measuring device.

According to another embodiment, at least one optical element, an optical element designed as a filter and/or an optical element designed as a lens is inserted in the transmission path.

The present disclosure and its advantages will now be explained in detail using the figures in the drawing, which show several examples of embodiments. The same elements are indicated by the same reference numbers in the figures.

### BRIEF DESCRIPTION OF THE DRAWINGS

The described embodiments and other features, advantages and disclosures contained herein, and the manner of attaining them, will become apparent and the present disclosure will be better understood by reference to the following description of various embodiments of the present disclosure taken in junction with the accompanying drawings, wherein:

FIG. 1 shows a schematic block diagram of a sensor according to the present disclosure;

FIG. 2 illustrates a sensor according to the present disclosure operating according to the fluorescence extinction principle;

FIG. 3 illustrates a sensor according to the present disclosure operating according to the attenuated total reflectance principle;

FIG. 4 shows a cross-sectional view of a sensor according to the present disclosure configured as an absorption sensor;

FIG. 5 shows a cross-sectional view of a sensor configured according to FIG. 1; and

FIG. 6 shows a cross-sectional view of a sensor configured according to FIG. 1 with a prism configured as a process separator.

### DETAILED DESCRIPTION

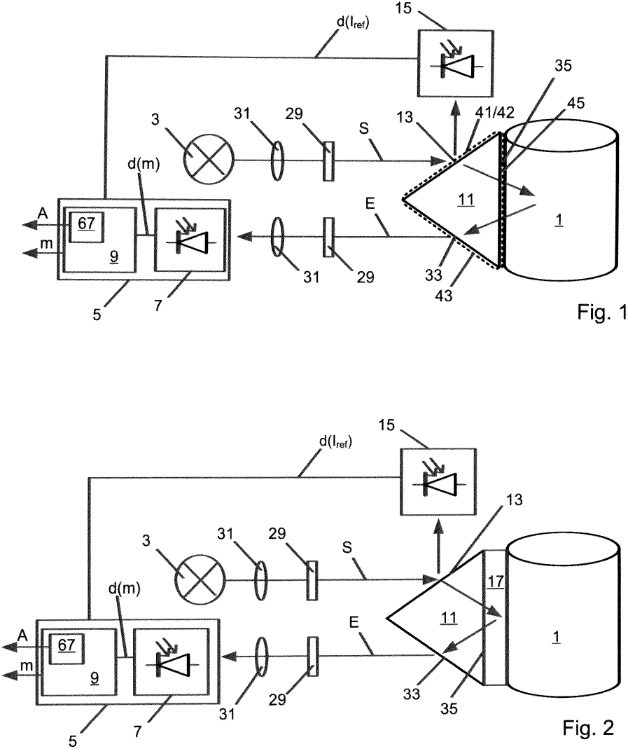

FIG. 1 shows a block diagram of a sensor for measuring a measurand of a medium 1. The sensor comprises a transmission device 3, such as a light source, which is designed to transmit electromagnetic transmitted radiation to the medium 1.

Moreover, the sensor comprises a measuring device 5 which is designed to receive measuring radiation resulting from an interaction of the transmitted radiation with the medium 1, to determine the measurand based on the received measuring radiation and to provide a measurement result m of the measurand.

A suitable measuring device 5 is, for example, a measuring device with a measuring detector 7 which receives the measuring radiation and outputs a detector signal d(m) dependent on the measurand. A suitable measuring detector 7 for electromagnetic radiation is, for example, a photodiode, a photodiode array or also a spectrometer. The detector signal d(m) can be provided directly as a measurement result. Alternatively, however, the measuring device 5 can also comprise measuring electronics 9 connected to the measuring detector 7, which determine a measured value of the measurand based on the detector signal d(m) and provide the measured value and/or a measurement signal corresponding to the measurement value as a measurement result m of the measurand.

As shown in FIG. 1, a prism 11 is inserted at the end of the transmission path S. This prism 11 is designed and arranged in such a way that a first portion of the transmitted radiation impinging on the prism 11 along the transmitting path S propagates through the prism 11 in the direction of the medium 1, and a second portion of the transmitted radiation impinging on the prism 11 along the transmitting path S is reflected at the prism 11. As shown in FIG. 1, the prism 11 in this case comprises, for example, a first outer surface 13 on which the transmitted radiation propagating along the transmission path S impinges.

Additionally, the sensor comprises a reference detector 15 which receives the second portion of the transmitted radiation reflected at the prism 11 and, based on the second portion, provides an output signal d(I)_{ref}, which reflects at least one property I_{ref} such as an intensity, a spectral intensity and/or an intensity spectrum of the second portion of the transmitted radiation reflected at the prism 11. A suitable reference detector 15 is, for example, a photodiode, a photodiode array or even a spectrometer.

The sensor has the above-mentioned advantages. Optionally, individual components of the sensor described here can each have different embodiments that can be used individually and/or in combination with one another.

Depending on the type of the measurand and/or the relevant embodiment of the sensor, different forms of the interaction of the transmitted radiation with the medium 1 can therefore be used.

One form of interaction is that at least part of the first portion of the transmitted radiation entering the medium 1 is reflected or scattered in the medium 1, or by particles or solid components contained in the medium. In this case, the measuring radiation is reflected or scattered radiation. In conjunction with this form of interaction, the sensor is designed, for example, as a turbidity sensor or as a sensor for measuring a solid concentration contained in the medium 1. In both cases, the transmission device 3 is designed, for example, as a light source by means of which light is transmitted into the medium 1. A suitable light source here is, for example, a light source such as an LED, an incandescent lamp, a flash lamp, gas discharge lamp or a laser which emits light in a wavelength range from 180 nm to 12,000 nm, in particular from 180 nm to 3,000 nm. With sensors based on reflection or scattering, the measuring device 5 is designed, for example, to determine an intensity of the measuring radiation that is dependent on the measurand such as turbidity or solids concentration, and/or to determine and output the measurement result m based on the intensity of the received measuring radiation.

An alternative embodiment consists in that the sensor, such as the sensor shown in FIG. 1, is designed as a fluorescence sensor. In fluorescence sensors, the interaction consists, for example, in that a fluorescent component contained in the medium 1 is excited to fluoresce by the first portion of the transmitted radiation irradiated into the medium 1. In this case, the measuring radiation is fluorescence radiation emitted by the component, and the measuring device 5 is designed to determine and output the measurand given here, for example, by a concentration of the component contained in the medium 1 on the basis of the intensity, the spectral intensity or the intensity spectrum of the measuring radiation. With sensors designed as a fluorescence sensor, the transmission device 3 is designed, for example, as a light source by means of which light with a wavelength range matched to the fluorescent component of the medium 1 is transmitted into the medium 1. For example, to measure the concentration of an analyte contained in the medium 1, it is possible to use, for example, an LED, an incandescent lamp, a flash lamp, gas discharge lamp or a laser as a transmission device 3 which emits transmitted radiation in a wavelength range from 180 nm to 12,000 nm, in particular from 180 nm to 3,000 nm.

As another exemplary embodiment, FIG. 2 shows a sensor operating according to the fluorescence extinction principle. This sensor differs from the sensor shown in FIG. 1 only in that a layer 17 in contact with the medium 1 is arranged on the side of the prism 11 facing the medium 1. This layer 17 contains fluorescent macromolecules on which molecules contained in the medium 1 can adhere such that they weaken the fluorescent light emitted by the macromolecules. In this case, the interaction of the transmitted radiation with the medium 1 consists in that the fluorescence of the macromolecules excited by the transmitted radiation is weakened by the adhering molecules of the medium 1. Here as well, the measuring device 5 is designed, for example, to determine and output the measurand given here, for example, by the concentration or a partial pressure of the molecules contained in the medium 1 based on the intensity, the spectral intensity or the intensity spectrum of the measuring radiation. Optionally, the sensor operating according to the principle of fluorescence quenching, such as the sensor shown in FIG. 2, is designed, for example, as an oxygen sensor. In this case, the layer 17 in contact with the medium 1 is designed as an oxygen-permeable layer, and the measuring device 5 is designed to determine and output the measurand given here by the oxygen partial pressure of the oxygen contained in the medium 1, for example.

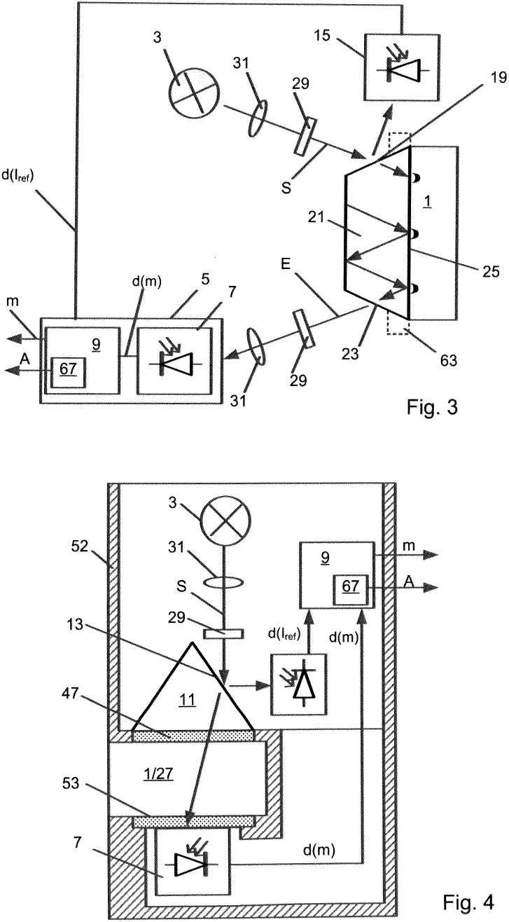

FIG. 3 shows another example of an ATR sensor operating according to the principle known under the term of “attenuated total reflection” (ATR). With this sensor as well, the transmission device 3 transmits transmitted radiation along the transmitting path S in the direction of a first outer surface 19 of a prism 21, also inserted here at the end side, in the transmission path S. This prism 21 is designed in such a way that the first portion of the transmitted radiation entering the prism 21 through the first outer surface 19 is reflected several times in the prism 21, and the resulting measurement radiation subsequently exits through a second outer surface 23 of the prism 21. The prism 21 has a third outer surface 25 facing the medium 1 which is in contact with the medium 1. In addition, the prism 21 is designed such that the reflections occurring in the prism 21 comprise at least one reflection at the third outer surface 25 in contact with the medium 1. In each of these reflections, an interaction with the medium 1 adjoining the third outer surface 25 takes place, by means of which the respective reflection is attenuated. Accordingly, the measuring device 5 is designed and/or arranged here in such a way that it receives the measuring radiation emerging via the second outer surface 25 of the prism 21 and attenuated by the interaction. With sensors designed as ATR sensors, the measurand is, for example, a concentration of an analyte which is determined by means of the measuring device 5, for example based on the absorption.

As another example, FIG. 4 shows a sensor designed as an absorption sensor. In this sensor, the interaction consists of at least part of the first portion of the transmitted radiation entering the medium 1 being absorbed in the medium 1. Here as well, the transmission device 3 is arranged such that the transmitted radiation impinges along the transmission path S on the first outer surface 13 of the prism 11, and the first portion of the transmitted radiation enters the medium 1 through the prism 11. In contrast to the previous exemplary embodiments, a transmission measurement takes place here, with which the first portion of the transmitted radiation is transmitted through the medium 1, and the measuring detector 7 of the measuring device 5 receives the measuring radiation emerging from the medium 1. For this purpose, the sensor has, for example, a recess 27 such as the measuring gap shown in FIG. 4 for receiving the medium 1. In this case, the prism 11 is arranged on one side of the recess 27, and the measuring detector 7 is arranged on the side of the recess 27 opposite the prism 11.

Irrespective of the previously described embodiments and/or the form of the employed interaction, the sensor can comprise, for example, at least one optical element 29, 31 inserted in the transmission path S. FIGS. 1 to 4 each show as examples an element 29 designed as a filter and an optical element 31 designed as a lens. In conjunction with optical elements 29, 31 inserted in the transmission path S, the second portion of the transmitted radiation reflected at the prism 11, 21 to the reference detector 15 offers the advantage that the reference detector 15 also automatically detects, in particular, changes in the property(ies) I_{ref} of the first portion of the transmitted radiation entering the medium 1 caused by each optical element 29, 31 inserted in the transmission path S. In particular, this allows the influence of temperature-dependent and/or aging-related changes in the optical properties of the optical elements 29, 31, such as changes or fluctuations in the filter characteristic of the filter and/or the imaging characteristic of the lens, on the first portion of the transmitted radiation interacting with the medium 1 to be measured. In addition, this also allows the influence of possibly occurring spatial displacements of the optical elements 29, 31, such as displacements caused by vibrations, on the transmitted radiation to also be detected by measuring.

Optionally, it is also possible to use at least one optical element 29, 31 such as, for example, the optical elements 29 designed as filters shown in FIGS. 1 to 4, and/or the optical elements 31 which are designed as a lens shown in FIGS. 1 to 4, in a reception path E extending to the measuring device 5 via which the measuring device 5 receives the measuring radiation.

Alternatively or in addition to the above-described embodiments, the prism 11, 21 can be designed differently depending on the type of sensor and/or the measurand to be measured. In this regard, FIGS. 1 and 2 show an embodiment with which the first outer surface 13 of the prism 11 on which the transmitted radiation impinges, a second outer surface 33 of the prism 11 and a third outer surface 35 of the prism 11 facing the medium 1 are arranged in a triangle. The prism 11 is inserted at the end into the transmission path S such that the transmitted radiation transmitted along the transmission path S to the prism 11 impinges on the first outer surface 13 of the prism 11 at an angle of incidence relative to the surface normal. Accordingly, the second portion of the transmitted radiation is reflected at the first outer surface 13 in a direction toward the reference detector 15, which extends perpendicular to the section of the transmitting path S impinging on the first outer face 13.

This embodiment is particularly advantageous when the interaction of the transmitted radiation with the medium 1 is an interaction with which the measuring radiation propagates at least also in a direction directed opposite the transmission direction through the prism 11. In this case, the sensor is designed such that the measuring radiation received by the measuring device 5 via the prism 11 exits from the prism 11 through the second outer surface 33 of the prism 11. In this embodiment, the reception path E preferably has a section extending antiparallel to the section of the transmission path S extending from the transmitting device 3 to the first outer surface 13 of the prism 11 and extending from the second outer surface 33 of the prism 11 to the measuring device 5.

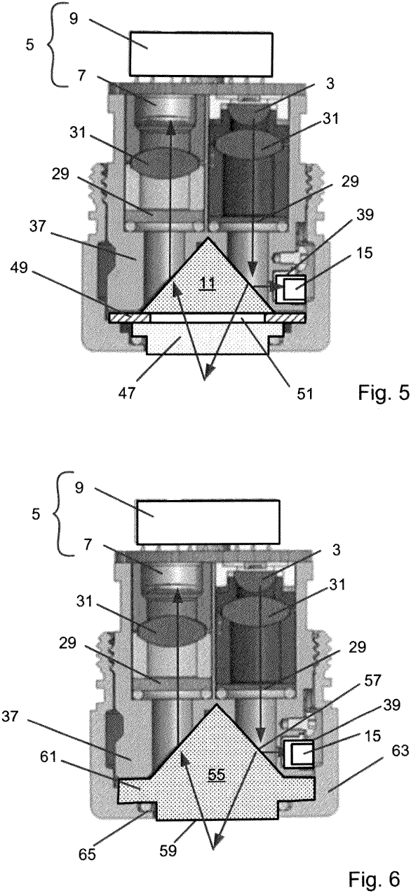

FIG. 5 shows a sectional drawing of an embodiment of the sensor shown in FIG. 1, with which the transmission device 3, the measuring device 5, the reference detector 15 and the prism 11 are arranged in a housing 37 such as a cylindrical housing. This enables a very compact design of the sensor.

In particular with regard to a very compact design of the sensor, the reference detector 15 is preferably arranged at a small distance from the prism 11, 21, such as a distance of 1 mm to 20 mm. For this purpose, the reference detector 15 is arranged, for example, in a region of the sensor surrounding the prism 11, 21 on the outside. In this regard, FIG. 5 shows an embodiment with which the reference detector 15 is arranged in a space-saving manner in a recess 39 in a housing wall of the housing 37 of the sensor. Similarly, the reference detectors 15 shown in FIGS. 1 to 4 can also be arranged in a region of the sensor that surrounds the particular prism 11, 21 to the outside, and/or in a recess in a housing wall of a housing of the sensor.

An additional optional embodiment consists in that a coating 41 or 42 is arranged on the first outer surface 13 of the prism 11 struck by the transmitted radiation transmitted to the prism 11. This coating 41, 42 shown in dashed lines in FIG. 1 as an optional feature can also be used analogously on the first outer surface of prisms, such as, for example, the prism 21 shown in FIG. 3, which have a different shape.

A partial mirror coating or an anti-reflection coating is suitable as a coating 41, for example. The partial mirror coating or the anti-reflection coating increases or respectively decreases the second portion of the transmitted radiation incident on the first outer surface 13 reflected at the first outer surface 13 of the prism 11. This offers the advantage that the intensity of the reflected second portion can be adjusted or set to an optimum intensity for the reference measurement that can be carried out by means of the reference detector 15 via the accordingly formed coating 41.

Alternatively, the coating can be designed as a spectrally selective coating 42. This embodiment is particularly advantageous if only a partial range of a wavelength spectrum of the transmitted radiation emitted by the transmission device 3 is relevant for the measurement of the measurand, and/or interference radiation is to be blanked out. In this respect, the spectrally selective coating 42 is designed, for example, as a filter. Depending on the type of the partial range of the wavelength spectrum and/or the interference radiation to be masked out, this filter is designed, for example, as a spectral filter which is permeable to one or more spectral lines, or as a bandpass filter which is transparent in a limited wavelength range. For this purpose, the spectrally selective coating 42 can be designed, for example, as an interference filter, as a dichroic filter or as a color filter. As a result, it is also possible, in particular, to carry out the reference measurement to be performed by the reference detector 15 at a different wavelength than the measurement of the measurand. The spectrally selective coating 42 has the advantage of being less expensive and requiring less space than conventional filters that can be inserted into the transmit path S as a single component.

Optionally, a spectrally selective coating 43, 45 can also be arranged on the second outer surface 33 of the prism 11, through which the measuring radiation exits from the prism 11, and/or on the third outer surface 35 of the prism 11 facing the medium 1. Analogous to the spectrally selective coating 42, one or each of these spectrally selective coatings 43, 45, each shown as an option in dashed lines in FIG. 1, is designed for example as a filter, a spectral filter or a bandpass filter. Corresponding spectrally selective coatings can be provided analogously on the corresponding outer surfaces of prisms having a different shape. These spectrally selective coatings 43, 45 each offer the advantage that they can limit the measuring radiation received by the measuring device 5 to one or more spectral lines relevant to the measurement of the measurand, or a wavelength range relevant to the measurement of the measurand. They are more cost-effective and require less space than a filter that can be inserted into the reception path E as an individual component.

Irrespective of the previously mentioned embodiments, the sensor can have, for example, a first window 47, which is inserted into a housing wall of the sensor and transparent to the transmitted radiation, through which the first portion of the transmitted radiation enters the medium 1. Examples of this are shown in FIGS. 4 and 5. There, the first window 47 has an outer side in contact with the medium 1, and the prism 11 is arranged on a side opposite the outer side of the first window 47 in the housing 37 of the sensor. With sensors, such as for example the sensors shown in FIGS. 1 and 5, with which the measuring radiation passes through the prism 11 to the measuring device 5, the measuring radiation also enters the prism 11 through the first window 47.

FIG. 5 shows an example with which the prism 11 is arranged in the sensor on an e.g., annular mounting element 49, which is arranged between the prism 11 and the first window 47. The mounting element 49 has at least one passage opening 51 through which the first portion of the transmitted radiation enters the medium 1, and through which the measuring radiation is received.

In the sensor shown in FIG. 4, the first window 47 is inserted into a housing wall region of the sensor housing 52 that borders the recess 27. In addition, a second window 53 is inserted into a housing wall region of the sensor housing 52 opposite the first window 47 on the other side of the recess 27, through which the measuring detector 7 of the measuring device 5 receives the measuring radiation.

As shown in FIGS. 4 and 5, the first window 47 forms a process separator by which an interior of the sensor is separated in a manner transparent to the emitted radiation or to the emitted radiation and the measurement radiation from the medium 1 located on the outside of the first window 47 during measurement mode.

An alternative embodiment provides that the prism 55 of the sensor is designed to simultaneously also take over the function of the first window 47 as a process separator. FIG. 6 shows, as an example, a modification of the sensor shown in FIG. 5, with which the prism 55 is designed as a process separator separating the interior of the sensor from the medium 1. For this purpose, the prism 55 is mounted, for example, on or in the housing 37 of the sensor such that it closes a housing opening in the sensor. In this case, the first outer surface 57 of the prism 55, through which the first portion of the transmitted radiation impinging thereon passes, and at which the second portion of the transmitted radiation is reflected to the reference detector 15, is arranged in the housing 37. Additionally, the third outer surface 59 of the prism 55 facing the medium 1 is arranged such that it is in contact with the medium 1 during measuring mode.

The prism 55 designed as a process separator can be mounted in different ways. As an example of this, FIG. 6 shows an embodiment with which the prism 55 has an outwardly projecting outer edge region 61, by means of which the prism 55 is fastened on or in the sensor. This edge region 61 can, for example, be connected to the housing 37 of the sensor by a joint or an adhesive bond. Alternatively, however, the edge region 61 can also be clamped in the sensor by means of a clamping device. FIG. 6 shows an embodiment of this, with which the outer edge region 61 is clamped between an end face of the housing 37 and a union nut 63 mounted on the housing 37, for example screwed on. The union nut 63 has a passage opening which releases the third outer surface 59 of the prism 55 in contact with the medium 1 during measuring mode. Regardless of the choice of the clamping device, the outer edge region 61 is clamped, for example, with the interposition of a seal 65, such as, for example, the seal 65 clamped between the outer edge region 61 and the union nut 63 in FIG. 6.

The prism 55 shown in FIG. 6 has a first region arranged in the housing 37, which comprises the first outer surface 57. Adjacent to the first region is a second region having the outwardly projecting outer edge region 61. In this case, the prism can be shaped such that the side of the second region facing away from the first region comprises the third outer surface. FIG. 6 shows an alternative embodiment, with which the prism 55 additionally has a third region which is arranged on the side of the second region opposite the first region and comprises the third outer surface 59. In this case, the third region has, for example, a smaller base area than the second region. Alternatively or additionally thereto, the third region is designed, for example, in such a way that the third outer face 59 terminates flush with an outer side of the sensor, such as, for example, the end face of the union nut 63.

Similarly, prisms with a different prism geometry than the triangular shape shown in FIG. 6 can also be designed as process separators. For example, the prism 21 shown in FIG. 3 can therefore be designed as a process separator in the manner described here using the example of the prism 55 shown in FIG. 6. In this regard, the prism 21 shown in FIG. 3 can also have, for example, an outwardly projecting outer edge region 61 shown as an option in dashed lines in FIG. 3, by means of which the prism 21 can be fastened or is fastened to or in a housing of the sensor not shown in FIG. 3.

Sensors with a prism 55, which is also designed as a process separator, provide the advantage over sensors with first windows 47 that the optical transitions between prism 11 and first window 47 are omitted. This achieves a more efficient, in particular low-loss use of the transmitted radiation. Additional advantages are that sensors without the first window 47 have fewer surfaces which may become soiled, and that the alignment of the prism 11 and the first window 47 to each another required with sensors having the first window 47 during production is omitted.

As described above, the reference detector 15 is designed to receive the second portion of the transmitted radiation reflected at the prism 11, 21, 55, and to provide, based on the second portion, an output signal d(I_{ref}) representing at least one property I_{ref} such as an intensity, a spectral intensity and/or an intensity spectrum, of the second portion of the transmitted radiation reflected at the prism 11, 21, 55. This output signal d(I_{ref}) can be used in different ways.

An embodiment shown in FIGS. 1 to 6 provides that the measuring device 5 is connected to the reference detector 15 and determines the measurement result m based on the received measuring radiation and the output signal d(I)_{ref}) of the reference detector 15. In this case, the measuring electronics 9 are preferably designed in such a way that they determine and make available the measurement result m as a measurement result compensated with respect to a dependence of a property of the measurement radiation, which is dependent on the measurand, on the property I_{ref} or at least one or each of the properties I_{ref} of the second component of the transmitted radiation reflected at the prism 11, 21, 55. In this way, for example, an intensity of the measuring radiation measured by means of the measuring detector 7 for determining the measurand can be compensated with respect to its dependence on the intensity of the transmitted radiation impinging on the prism 11, 21, 55. In so doing, all factors influencing the property(ies) I_{ref} of the transmitted radiation that may impinge on the prism 11, 21, 55 are automatically taken into account. These include, for example, changes of the transmitted radiation caused by aging phenomena and/or temperature dependencies of the transmitter device 3, along with any changes that may occur in the transmitted radiation emitted by the transmitting device 3 along the transmission path S until it strikes the prism 11, 21, 55. This offers the advantage of a correspondingly low measurement error of the measurement result m.

Alternatively or additionally, the sensor comprises, for example, a monitoring device 67 connected to the reference detector 15, which is designed to monitor the property I_{ref}, or at least one or each of the properties I_{ref}, of the second portion of the transmitted radiation reflected at the prism 11, 21, 55, and/or to output an alarm A if the I_{ref} property, or at least one of the I_{ref} properties, lies outside a setpoint range specified for the respective property I_{ref}. In this respect, for example, an alarm A can be output if the intensity of the second portion of the transmitted radiation received by the reference detector 15 falls below a predetermined minimum value. In FIGS. 1 to 4, the monitoring device 67 is designed as a component of the measuring electronics 9. Alternatively, however, the monitoring device 67 can also be designed as a separate device connected to the reference detector 15.

Claimed is:

1. A sensor for measuring a measurand of a medium, the sensor comprising:
a transmission device configured to transmit electromagnetic radiation along a transmitting path to the medium;
a measuring device configured to receive measuring radiation resulting from an interaction of the transmitted radiation with the medium, to determine the measurand based on the received measuring radiation, and to provide a measurement result of the measurand;
a prism disposed at the end into the transmission path, wherein the prism is configured and arranged such that a first portion of the transmitted radiation incident on the prism propagates through the prism in a direction of the medium, and a second portion of the transmitted radiation incident on the prism is reflected at the prism; and
a reference detector configured to receive the second portion of the transmitted radiation reflected at the prism and to provide, based on the second portion, an output signal representing at least one property of the second portion of the transmitted radiation reflected at the prism.

2. The sensor of claim 1, wherein the sensor is configured as one of: a turbidity sensor; a sensor for measuring a solid concentration contained in the medium; a fluorescence sensor; a sensor operating according to the principle of fluorescence quenching; an oxygen sensor operating according to the principle of fluorescence quenching; an attenuated total reflection sensor operating according to the principle of attenuated total reflectance; or an absorption sensor.

3. The sensor of claim 1, wherein a coating is disposed on a first outer surface of the prism on which the transmitted radiation transmitted along the transmission path impinges, wherein the coating is configured as one of: a partial reflection coating, an anti-reflection coating, or a spectrally selective coating.

4. The sensor of claim 1, wherein a spectrally selective coating is disposed on a second outer surface of the prism, through which measuring radiation emerges from the prism, and/or a spectrally selective coating is disposed on a third outer surface of the prism facing the medium.

5. The sensor of claim 3, wherein the spectrally selective coating or at least one of the spectrally selective coatings is configured as an interference filter, as a dichroic filter, as a color filter, as a spectral filter that is transparent to one or more spectral lines, or as a bandpass filter that is transparent to a limited wavelength range.

6. The sensor of claim 1, wherein the prism:
is configured as a process separator through which an interior of the sensor is separated from the medium; and/or
is mounted on or in a housing of the sensor such that the prism closes a housing opening of the sensor; and/or
includes a first outer surface arranged in the housing of the sensor, through which the first portion of the transmitted radiation incident thereon passes and on which the second portion of the transmitted radiation is reflected to the reference detector, and includes a third outer surface in contact with the medium during measuring mode.

7. The sensor of claim 6, wherein the prism has an outwardly projecting outer edge region, wherein the prism is fastened to or in the sensor by the outer edge region, and/or the edge region is one of: connected to the housing of the sensor by a joint or an adhesive bond; clamped in the sensor by a clamping device; or clamped between an end face of the housing and a union nut mounted on the housing.

8. The sensor of claim 7, wherein the prism:
includes a first region arranged in the housing and comprising the first outer surface; and
includes a second region, which comprises the outwardly projecting outer edge region,
wherein the second region either comprises the third outer surface or adjoins a third region of the prism, which comprises the third outer surface, wherein the third region has a smaller base area than the second region and/or is configured such that the third outer surface terminates flush with an outer side of the sensor or an end face of the union nut.

9. The sensor of claim 1, wherein the measuring device is connected to the reference detector, and the measurement result is determined based on the received measuring radiation and the property, at least one of the properties, or each of the properties, of the second portion of the transmitted radiation reflected at the prism.

10. The sensor of claim 1, wherein:
the measuring device comprises a measuring detector configured to receive the measuring radiation and to output a detector signal dependent on the measurand;
the measuring device comprises measuring electronics connected to the measuring detector; and
the measurement electronics are configured to determine and provide the measurement result as a measurement result compensated with respect to a dependence of a property of the measurement radiation, which is dependent on the measurand, on the property, at least one of the properties or each of the properties of the second portion of the transmitted radiation reflected at the prism.

11. The sensor of claim 1, wherein a monitoring device is connected to the reference detector and is configured to monitor the at least one property of the second portion of the transmitted radiation reflected at the prism and/or is configured to output an alarm if the at least one property is outside a setpoint range specified for the respective property.

12. The sensor of claim 1, wherein the reference detector is disposed in a housing of the sensor in a region externally surrounding the prism and/or is disposed in a recess in a housing wall of the housing of the sensor.

13. The sensor of claim 1, wherein a first outer surface of the prism on which the transmitted radiation impinges, a second outer surface of the prism, and a third outer surface of the prism facing the medium are arranged in a triangle.

14. The sensor of claim 13, wherein:
the measuring device receives the measuring radiation via a reception path; and
the reception path comprises a section extending antiparallel to a section of the transmission path extending from the transmitting device to the first outer surface of the prism and extending from the second outer surface of the prism to the measuring device.

15. The sensor of claim 1, wherein at least one optical element, an optical element configured as a filter, or an optical element configured as a lens is arranged in the transmission path.
